(19) United States
(12) Patent Application Publication
(10) Pub. No.: US 2013/0060680 A1
(43) Pub. Date: Mar. 7, 2013

(54) FUNDS MANAGEMENT SYSTEMS AND METHODS

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC.

(21) Appl. No.: 13/226,182

(22) Filed: Sep. 6, 2011

(51) Int. Cl. G06Q 40/00

(52) U.S. Cl. 705/39

(57) ABSTRACT

Described herein are systems, methods, and articles of manufacture that establish services that facilitate funds management. These services can manage multiple accounts of different types for the same user (either payer or payee). The services can also link a payee account and a payer account to establish electronic funds transfers and other transactions. The services can also facilitate the establishment of an electronic funds transfer through enabling a search for either a payee or a payer according to a criterion.

### TECHNICAL FIELD

This disclosure relates generally to services that can facilitate funds management.

### BACKGROUND

Many banks offer funds management services, such as online banking and online bill payment. Generally, a user can make payments to a third party payee from the funds management service, as long as the funds management service has a record of the third party payee within its offerings. This record can include account information for the third party payee to facilitate transactions between the user and the third party payee.

To establish these transactions between the user and the third party payee, the user can search the service's offerings for the third party payee. If the payee is found within the service's offerings, the transaction between the user's account and the third party payee's account can be established. If the payee is not found within the service offerings, however, the user must enter information about the third party payee into the service's offerings. For example, the user can enter account details for the third party payee. These account details are often confidential and not known to the user.

The above-described deficiencies of conventional funds management services and practices are merely intended to provide an overview of some of problems of current technology, and are not intended to be exhaustive. Other problems with the state of the art and corresponding benefits of some of the various embodiments described herein may become further apparent upon review of the following detailed description.

### SUMMARY

The following description and the annexed drawings set forth in detail certain illustrative aspects of some of the various embodiments of funds management services. These aspects are indicative, however, of but a few of the various ways in which the principles of the various embodiments can be employed. The various embodiments described herein are intended to include all such aspects and their equivalents. Other advantages and distinctive features of the various embodiments will become apparent from the following detailed description of the various embodiments when considered in conjunction with the drawings.

Described herein are systems, methods and articles of manufacture that facilitate funds management. One example of funds management is electronic funds management which can enable a user to establish electronic payments with any payee, even if the payee is not already associated with a provider of the user's account, without manually entering details about the payee. The systems, methods and articles of manufacture described herein can be implemented in connection with any type of device with a connection to a communications network (a wireless communications network, the Internet, or the like), such as a mobile handset, a computer, a handheld device, or the like.

According to an embodiment, described herein is a system that facilitates funds management. The system can include an account management component configured to manage a first account and to manage a second account. The system can also include a selection component configured to display a list of a plurality of payees based on a type of payee and to receive a selection of a payee from the plurality of payees. The system can also include a transaction component configured to perform an action related to the first account or the second account and the payee.

According to another embodiment, described herein is a method that facilitates funds management. The method can include managing a first account and a second account. The first account and the second account can be of different types. The method also can include searching for a plurality of registered payees based on a criterion and displaying a list of the plurality of registered payees. The method can further include receiving a selection of a payee from the plurality of payees and completing an action regarding the first account or the second account and the payee.

In a further embodiment, described herein is a system that establishes a transaction between a payer and payee. The system can include a registration component configured to receive from an entity an account database comprising a plurality of account information for a plurality of users. The system can also include a search component configured to search the account database for a user and receive account information associated with the user. Further, the system can include a payment component configured to link the user and the entity.

In another embodiment, described herein is a method that establishes a transaction between a payer and a payee. The method can include receiving from an entity an account database comprising a plurality of account information for a plurality of users. The method also can include searching the account database for a user and receiving account information associated with the use. The method also can include linking the user and the entity for electronic transactions and establishing an electronic transaction between the user and the entity.

According to yet another embodiment, described herein is a system that establishes a transaction between a payer and a payee. The system can include a search component configured to search a database for a payee based on a criterion of the payee. The system can also include a retrieval component configured to retrieve account information of the payee. The system can also include a confidentiality component configured to select a portion of the account information comprising non-confidential information so that the payer can establish a transaction without seeing confidential information.

According to a further embodiment, described herein is a method establishes a transaction between a payer and a payee. The method can include searching for a payee based on a criterion of the payee and retrieving account information for the payee. The method can also include displaying a portion of the account information and receiving a selection of the payee based on the portion of the account information. The method can further include linking the payee and a payer based on the selection and establishing a transaction between the payer and the payee.

According to yet another embodiment, described herein are articles of manufacture, such as a computer readable storage medium or the like. The articles of manufacture can store the instructions that, when executed by a computing device, can facilitate management of funds.

These and other embodiments are described in more detail below with reference to the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a schematic system block diagram of a system that facilitates funds management according to an embodiment.

FIG. 2 illustrates a schematic system block diagram of a system that facilitates funds management according to an embodiment.

FIG. 3 illustrates a schematic process flow diagram of a method that facilitates funds management according to an embodiment.

FIG. 4 illustrates a schematic system block diagram of a method that establishes a transaction with a friend according to an embodiment.

FIG. 5 illustrates a schematic system block diagram of a system that establishes a transaction between a payer and payee according to an embodiment.

FIG. 6 illustrates a schematic system block diagram of a system that schedules a transaction between a payer and payee according to an embodiment.

FIG. 7 illustrates a schematic process flow diagram of a method that facilitates linking a payee and a payer according to an embodiment.

FIG. 8 illustrates a schematic process flow diagram of a method that facilitates establishment of a transaction between a payee and a payer according to an embodiment.

FIG. 9 illustrates a schematic system block diagram of a system that ensures only non-confidential account information is displayed according to an embodiment.

FIG. 10 illustrates a schematic system block diagram of a system that establishes a transaction between a payer and payee according to an embodiment.

FIG. 11 illustrates a schematic process flow diagram of a method that facilitates linking a payee and a payer according to an embodiment.

FIG. 12 illustrates a schematic process flow diagram of a method that establishes a transaction between a payee and a payer according to an embodiment

FIG. 13 illustrates an example schematic diagram of a mobile device (e.g., a mobile handset) that can facilitate the funds management services in accordance with the embodiments described herein.

FIG. 14 illustrates a block diagram of a computer operable to execute a system architecture that facilitates the funds management services according to the embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies and other drawbacks of online funds management services, various systems, methods and articles of manufacture described herein to facilitate funds management.

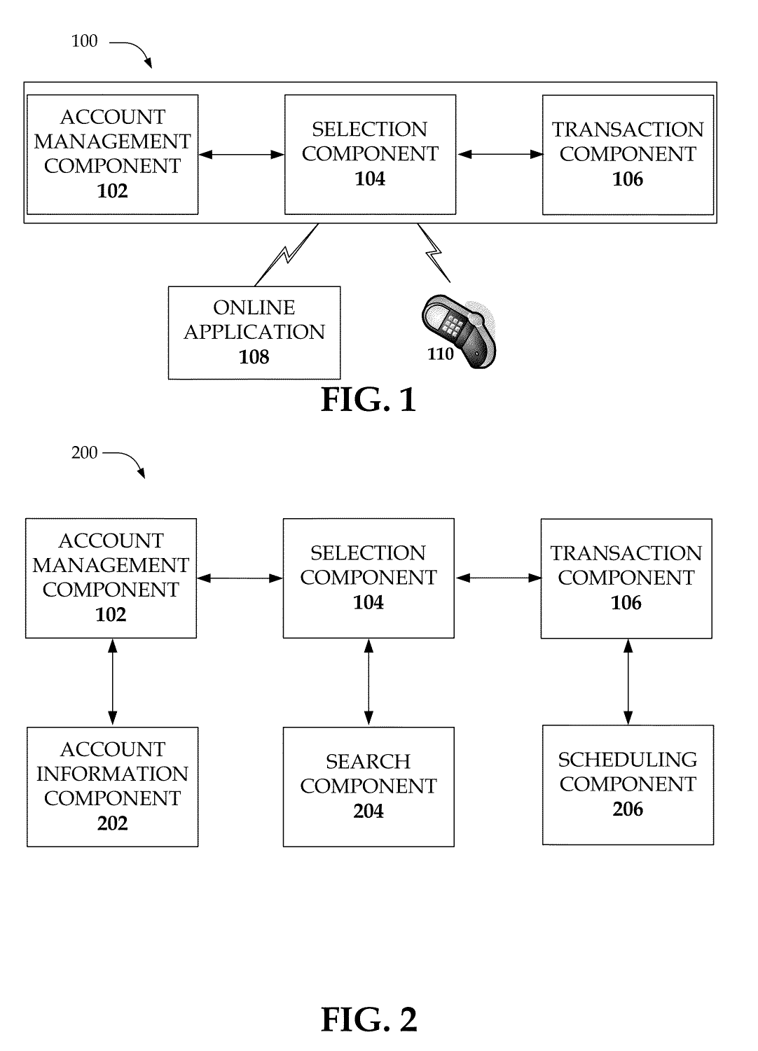

Referring now to FIG. 1, illustrated is a schematic system block diagram of a system 100 that facilitates funds management. The funds managed can be personal funds. The funds managed can also be business funds and/or financial institution funds. Accordingly, system 100 can include an account management component 102 that can manage a first account and can manage a second account. The first account and the second account can be different types of accounts, such as a savings account, a checking account, a credit card account, a loan account, or the like. Additionally, the first account and the second account can be associated with different institutions (banks) For example, the first account can be a checking account from Bank of America, while the second account can be a Visa card from Capital One. The account management component 102 can create an interface from which a user can access various accounts (e.g., from a mobile phone). The user no longer needs to go to separate Web sites or install multiple software applications to access account information, like a Web site for bank account information and a separate Web site for credit card information.

The account management component 102 can provide an interface for managing accounts. These accounts can be all controlled or managed by an entity, such as a user, a business, a bank, or a machine. The interface can be a computer application, a mobile application, an online application, or the like. Accordingly, the account management component 102 can provide an e-wallet that allows a user to affiliate bank accounts, credit accounts, debit accounts, and the like after registration with system 100. The system 100 can be affiliated with a system that allows the user to affiliate banking accounts with the system, for example, so that when the user visits an e-commerce site affiliated with the system, the user can be presented with an option to pay with the registered account. By selecting this option, the user can be directed to a new Web site or application browser window that can provide a secure connection to the account management component 102, which can provide a list of some or all linked accounts. The list can include balances of each account, pending credits or debits, or the like. The user can select one or more of the accounts to complete a purchase from the e-commerce site with a pseudo account number.

In another example, a user can register with the system and affiliate multiple accounts, such as bank accounts, credit cards, loans, bills, and the like. To affiliate an account, a user can enter required details (account number, provider information, and the like) and sign any required release. After affiliation, the account management component 102 can allow a user to view an account balance, recent transactions, pay bills, and the like, all in a location, such as a single location, with no manual entrances of transactions. Additionally, the account management component 102 facilitates transfers of money between accounts. If the account manager 102 is installed as part of an online bank, the user can access other banking services, such as opening new accounts, applying for a loan, and the like.

The system 100 can include a mechanism to establish transactions between the user and a payee even if the user does not enter the payee information. The system 100 can also include a selection component 104 that can receive a type of payee. Based on the type of payee, the selection component 104 can display a list of a plurality of payees that satisfy the type. The type can be any quality of a payee, such as a service type, a location, a name, and the like. For example, the type of payee could be “cable provider,” and the selection component can display a list including “Time Warner,” “Cox,” “AT&T,” “Verizon,” and “DishNetwork.” The type can include more than a single type. A second type can filter the list further. According to the previous example, a second type can be “Strongsville, Ohio.” The list can be filtered to remove “Verizon” and “Cox” from the list because “Verizon” and “Cox” are not cable providers in Strongsville, Ohio. The list would then include “Time Warner,” “AT&T,” and “DishNetwork.”

The selection component 104 can receive a selection of one or more of the plurality of payees. The selection can be based, for example, on services provide to a user. According to the previous example, a user can select “AT&T” from the list because the user receives AT&T U-Verse cable services and owes AT&T a payment for services provided.

The type searched by the selection component 104 can also be “friend,” “family,” “business associate,” or the like. In the case where the type is “family,” the selection component 104 can display a list of all family members registered with system 100 (e.g., have an account with system 100). If “mom,” “dad,” “aunt,” “uncle,” “sister,” and “son” are all registered with the system 100, then the selection component 104 can display a list that includes “mom,” “dad,” “aunt,” “uncle,” “sister,” and “son.” The selection component 104 can display the list based on a social graph (a global mapping of how people are related online, such as “friends” on a social network).

The selection component 104 can receive a name (“Joe Smith”) or a type (“family” or “brother”), and then search a database or data store of registered users with the name or the type. If the name or type is found in the database of registered users, “Joe Smith” can be added to the list of family members that is displayed. If the name of type is not found in the database of registered users, system 100 can provide “Joe Smith” with instructions detailing how to register with system 100 via a received e-mail addressed or other contact information. Upon successful registration, “Joe Smith” can be added to the displayed list of family members.

System 100 can also include a transaction component 106 that can perform an action related to the first account or the second account and the payee. The action can include setting up a payment from the first account or the second account to the payee. According to the “cable company” example, a payment can be established through an online transaction from a checking account, savings account, or credit card to AT&T. The action can also include setting up a payment that is split between accounts to the payee. For example, a bill can be $100 from AT&T, and $75 can be transferred from a checking account to AT&T, $15 can be transferred from a savings account to AT&T, and $10 can be transferred from a credit card to AT&T. The action can also include scheduling a future transaction (one time or periodic) between the payee and payer. With regard to the previous example, a monthly payment can be set up so that the monthly bill of $100 is paid from a checking account to AT&T on the 15^{th} of every month. Also, in a similar way, transaction component 106 can facilitate transactions between “friends,” “family,” “business associates,” and the like, who may have accounts at different banks and whose account number may not be known or shared.

The system 100 can also include a validation component (not shown) that can validate identities of the user and/or the registered users. This can, for example, work to prevent identity theft, fraud, and other improper uses of financial information of a user. For example, the validation component can employ an algorithm that can verify the identity of the user and/or the registered user.

The system 100, as well as any subsequently described system or method, can be part of an online application 108. These systems and methods can also be executed in connection with a mobile device 110.

Referring now to FIG. 2, illustrated is a schematic system block diagram of a system 200 that facilitates funds management. The funds management can include personal funds management, business funds management, or the like. The system can include the account management component 102, the selection component 104, and the transaction component 106 as described above. The system can also include an account information component 202 that can work with the account management component 102 to facilitate management of the accounts, a search component 204 that can perform additional functionality of the selection component 104 and a scheduling component 204 that can provide additional functionality for the transaction component 104.

The account information component 202 can have functionality similar to that of an automatic teller machine (ATM). The account information component 202 can display prompts similar to an ATM interface that allows a user select options including viewing an account balance, viewing recent transactions, paying bills, and the like, but different from an ATM, the account information component 202 allows a user to view each of these options from multiple accounts (e.g., the first account and the second account). The account information component 202 can also allow a user to select an option to transfer money between accounts managed by the account management component 102. The account information component 202 can provide further options that facilitate selection of functionalities provided for multiple accounts managed by the account management component 102.

The search component 204 can be utilized by the selection component 202 to perform searches (e.g., of an account database, a provider database, or any database in connection with system 100). The search component 204 can receive a criterion from the selection component 102 (e.g., a type as previously described) and perform searches based on the criterion. The search component 204 can also provide suggestions to a user of potential criteria, such as a list of types that the user can choose between. The search component 204 can provide the suggestions based on a schedule (e.g., a periodic time) when bills are often due. For example, on the 15^{th} of the month, the search component 204 can suggest types of bills, such as “electric provider,” “gas provider,” “cable provider,” and the like. The search component 204 can also suggest transaction between friends, family or business associates. For example, the search component 204 can suggest a specific “friend” on that friend's birthday so a money transfer can be initiated as a birthday present. The search component 204 can employ various artificial intelligence techniques (e.g., stored or historical data analysis, neural network, classifier, support vector machine, or the like) to facilitate the suggestion.

The scheduling component 206 can provide the transaction component 106 with additional functionality. The scheduling component 206 can schedule events. For example, the scheduling component 206 can provide a one-time action or a recurring action. The scheduling component 206 can suggest recurring transactions (e.g., for recurring bill payment) or even automatically implement court-ordered recurring payments, such as child support. The scheduling component 206 can employ artificial intelligence techniques (e.g., stored or historical data analysis, neural network, classifier, support vector machine, or the like) to facilitate the suggestion.

The search component 204 or the scheduling component 206 can employ various artificial intelligence-based schemes or techniques for carrying out various functionalities. One type of artificial intelligence-based technique employs a classifier, a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action to be automatically performed (e.g., suggestions from the search component 204 or the scheduling component 206).

A support vector machine (SVM) is an example of a classifier that can be employed. The SVM can determine a hypersurface in the space of possible inputs that can attempt to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, probabilistic classification models providing different patterns of independence, and the like. Classification is also inclusive of statistical regression that is utilized to develop models of priority.

Classifiers can be explicitly trained (e.g., via a generic training data) or implicitly trained (e.g., via observing user behavior, receiving extrinsic information, like historical data). For example, SVMs can be configured via a learning or training phase within a classifier constructor and feature selection module. Thus, the classifiers can be utilized to automatically learn and perform a number of functions, such as offering various suggestions, employed by the search component 204 or the scheduling component 206.

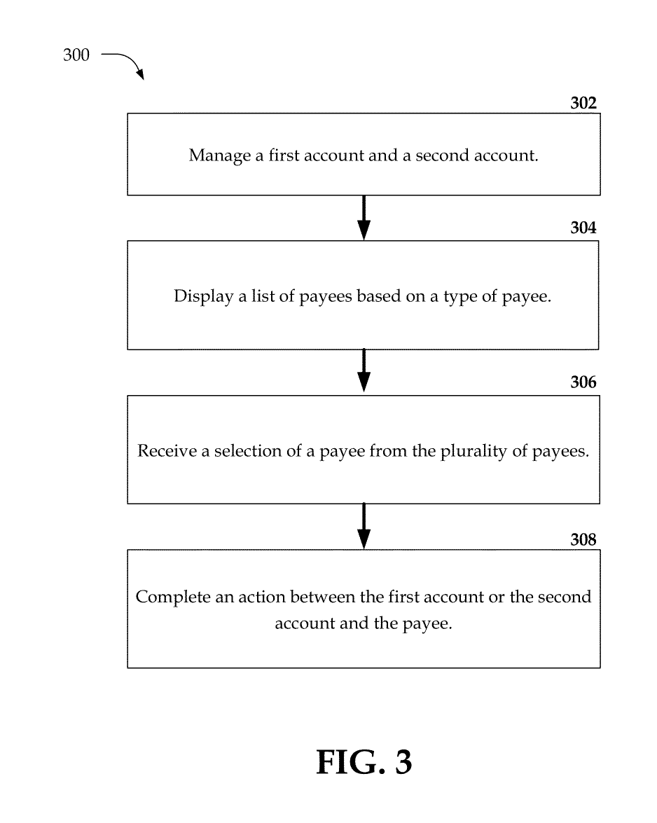

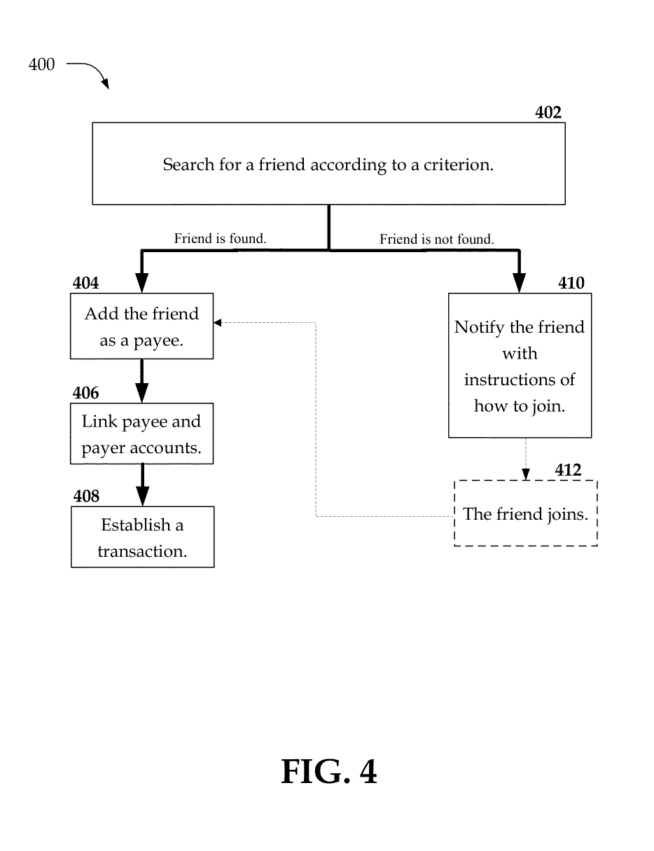

FIGS. 3-4 illustrate methods that facilitate funds management. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media, including a non-transitory computer readable storage medium.

Referring now to FIG. 3, illustrated is a schematic process flow diagram of a method 300 that facilitates funds management. The method 300 can provide a location from which a user can access various accounts (e.g., from a mobile phone, an online application, a computer application, and the like). The location can be a single location. At element 1302, a first account and a second account can be managed at the location. The first account and the second account can be different types of accounts, such as a savings account, a checking account, a credit card account, a loan account, or the like. Additionally, the first account and the second account can be associated with different institutions (banks) For example, the first account can be a checking account from Bank of America, while the second account can be a Visa card from Capital One.

A user to view account details for the first account and the second account together. The user can view an account balance of one or both of the first account and the second account based on a selection. The user can also view recent transactions with regard to one or both accounts, pay bills from one or both accounts, and the like. The first account and the second account can be managed without manual entrances of transactions and, instead, can update automatically. Money can be transferred between the first account and the second account and also between the first account or the second account and a third party account that is registered to receive such transactions.

Third party accounts can be located or identified at element 302 where a list of payees is displayed based on a type. The type can be any quality of a payee, such as a service type, a location, a name, and the like. The type can also include a friend, a relative or a business associate. The list of payees can be filtered according to another type. The list of payees can be identified, for example, by searching a database of registered users or a database of known providers that other registered users have previously used. For example, “Joe Smith” can be found in a database of registered users, while “AT&T” can be found a database of known providers because many registered users in the same area as the current user have entered into transactions with “AT&T.”

At element 306, a user can make a selection from the list and, upon receipt of the selection, a payee can be set. A user can be given the opportunity to approve, cancel or change the suggestion. Then, at element 308, an action can be completed between the first account or the second account and the payee. The user can define the action, such as a payment, an electronic funds transfer, or scheduling a future event, or the like. The user can also select which account will engage in the action. For example, the payment can be made from the first account, the payment can be made from the second account, or the payment can be made by the first account paying a certain amount and the second account paying another amount.

Referring now to FIG. 4, illustrated is a schematic system block diagram of a method 400 that establishes a transaction with a friend (relative, business associate, or the like). At element 402, a search for a friend can be conducted according to a certain criterion. The search can be through a database of registered users. The criterion can be a name, a location, a relation, or the like. Artificial intelligence techniques can also be employed, for example, based off a social graph, a historical relationship, or the like.

If the friend is found in the database, the method can proceed to element 404 where the friend can be added as a payee. At element 406, the payer and payee accounts can be linked without sharing any confidential information, and at element 408, a transaction can be established.

If the friend is not found in the database, the method can proceed to element 410, where the friend can be notified with instructions of how to join and register. The friend can be notified according to contact information, such as an e-mail address, provided by the user. If the friend subsequently joins and registered at element 412, the method 400 can proceed to element 404 where the friend is added as a payee and proceed to establish the transaction at element 408 by linking payee and payer accounts at element 408.

Although not illustrated, the method can also include requesting approval by the friend before any link can be made to the user. For example, John can request to link to an account held by Jane. Jane can receive a notification of the request and can accept or decline the request. According to another example, this acceptance or denial can be automated.

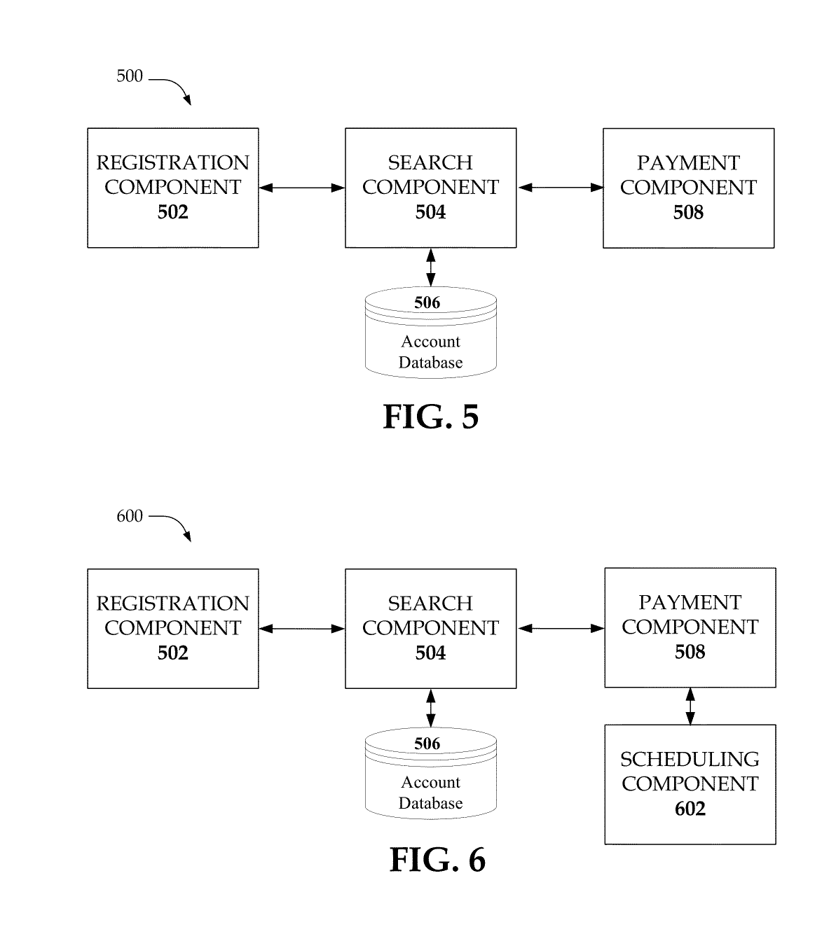

Referring now to FIG. 5, illustrated is schematic system block diagram of a system 500 that establishes a transaction between a payer and payee. The system can include a registration component 502 that can receive an account database 506 from an entity that can include account information of registered users. The entity can be, for example, a utility company and the account information can include billing account numbers for the utility company rather than bank account information for the user. The entity can be any service provider, including a credit card company, a loan services company, a utility company, a mobile phone company, or the like.

In the case where the entity is a utility company, the utility company can register with system 500 through the registration component 502. The utility company can provide associated bank account information that transactions and payments can be made to. The utility company can also provide an account database 506 with user utility service account information to the registration component 502, which can connect the account database 506 with the system 500. Alternatively, a banking institution associated with the utility company can complete registration through the registration component 502 on behalf of the company. The banking institution can mark various accounts of the utility company with various ID to distinguish multiple accounts of the utility company that can be utilized for different purposes.

Alternatively, a user can register with system 500 through the registration component 502. The user can provide one or more accounts, such as bank accounts, credit card accounts, loan accounts, and the like. The registration component 504 can search information about payees from the one or more accounts (e.g., search a checking account associated with the user, upon permission from the user, and find an electronic transaction with a utility company, another transaction with a cable company, and another electronic transaction with a mobile phone company). The registration component can establish these payees as payees associated with the user.

The system 500 can also include a search component 504 that can search the account database 506 for a user based on a criterion (e.g., name, address, account number, or the like) and receive account information associated with the user. For example a user of system 500 can search the account database 506 through the search component 504 according to a name associated with the account and find the account number associated with the user.

The system 500 can also include a payment component 508 that can link a payment account from the user with the entity. For example, the payment account can be a bank account or a credit card account registered with system 500. The user can be the payer and the entity a payee in this situation. The payment component 508 can receive information regarding credits or debits associated with the user from the entity. This can allow the payment component 508 to notify the user that a payment is required or that a payment has been received by the entity. The payment component 508 can also allow the user to view bills, billing statements, and the like related to the user's account.

Referring now to FIG. 6, illustrated is a schematic system block diagram of a system 600 that schedules a transaction between a payer and payee. The system 600 can include the registration component 502, the search component 504, the account database 506 and the payment component 508 with functionalities described with regard to FIG. 5. System 600 can also include a scheduling component 602.

The scheduling component 602 can provide the payment component 508 with additional functionality. The scheduling component 602 can schedule events, such as payments from the payer to the payee. For example, the scheduling component 602 can provide a one-time payment or a recurring payment. The scheduling component 602 can suggest recurring transactions (e.g., for recurring bill payment) or even automatically implement court-ordered recurring payments, such as child support, if the receiving entity is registered with the system 500. The scheduling component 602 can employ artificial intelligence techniques (e.g., stored or historical data analysis, neural network, classifier, support vector machine, or the like, as described above with respect to FIG. 2) to facilitate the suggestion.

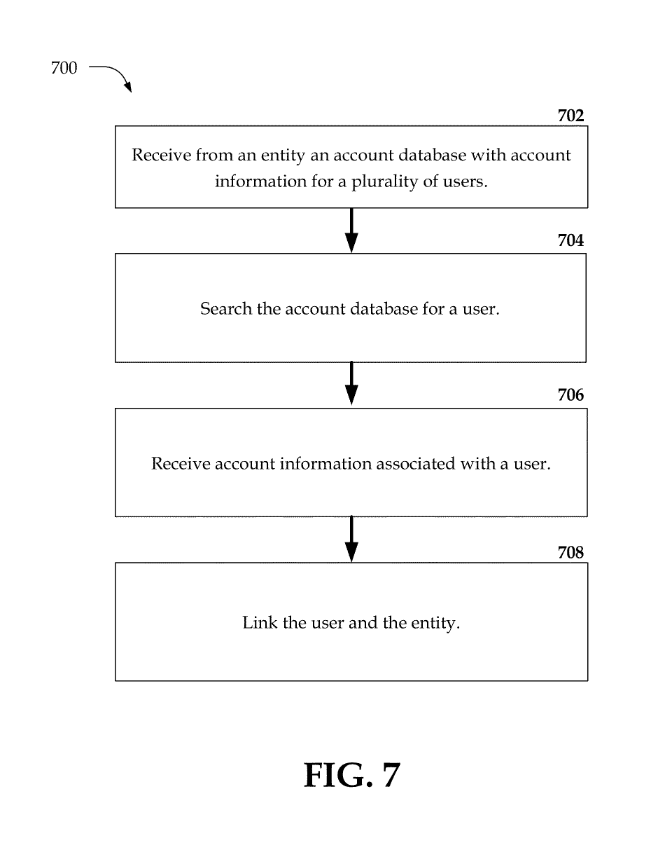

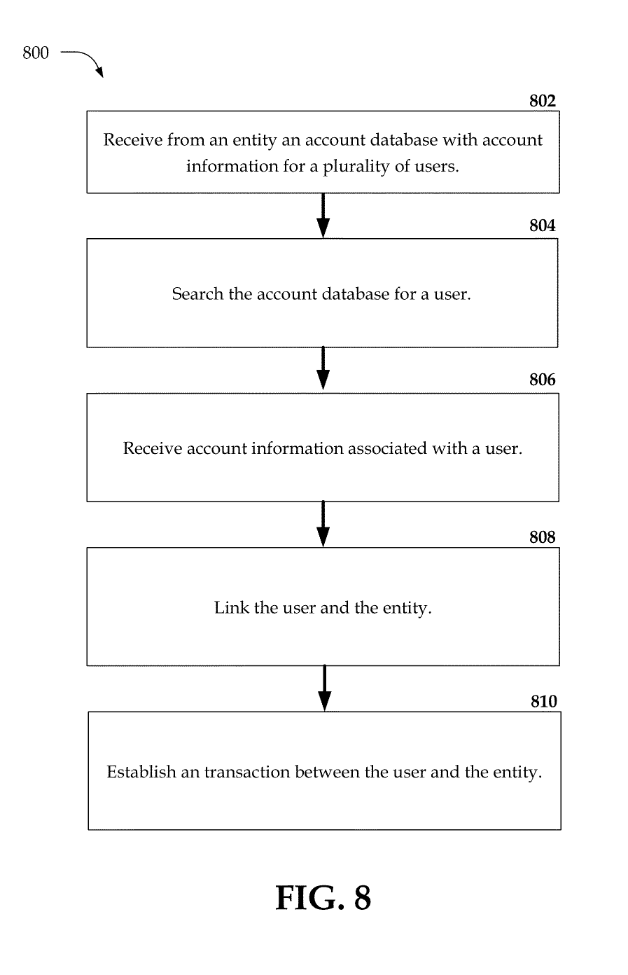

FIGS. 7-8 illustrate methods that facilitate establishing a transaction between a payee and a payer. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media, including a non-transitory computer readable storage medium.

Referring now to FIG. 7, illustrated is a schematic process flow diagram of a method 700 that facilitates linking a payee and a payer. The method begins at element 702, where an account database including account information for a plurality of users can be received from an entity. The entity can be any service provider, including a credit card company, a loan services company, a utility company, a mobile phone company, or the like. The account information can include an account number for a service provided by the entity. The entity can provide account information for an account that is associated with the entity (e.g., to receive payments.

Alternatively, the entity can be a user that can provide registration information (including at least one bank account). An account database of payees for the user can be created be searching information about payees from the at least one bank account. According to an example, a user can provide registration information including a checking account and an associated waiver form. A search can be conducted for various electronic transactions, and an electronic transaction with a utility company, another transaction with a cable company, and another electronic transaction with a mobile phone company can be found. The utility company, the cable company, and the mobile phone company can be added to the account database of payees as payees associated with the user.

At element 704, the account database can be searched. A user can search the account database provided by the entity for his account information (e.g., by entering his name, address, or the like). The user can search the account database of payees for a certain payee (e.g., according to a name, an address, a type, or the like). At element 706, in both cases, account information can be received associated with the user (e.g., an account number related to utility services). At element 708, the user and the entity (or payee) can be linked for an electronic transaction.

Referring now to FIG. 8, illustrated is a schematic process flow diagram of a method 800 that facilitates establishment of a transaction between a payee and a payer. At element 802, an account database including account information for a plurality of users can be received from an entity or an account database including payees associated with a user can be mined from a user bank account. At element 804, the account database can be searched. A user can search the account database provided by the entity for his account information (e.g., by entering his name, address, or the like). The user can search the account database of payees for a certain payee (e.g., according to a name, an address, a type, or the like). At element 806, in both cases, account information can be received associated with the user (e.g., an account number related to utility services). At element 808, the user and the entity (or payee) can be linked for an electronic transaction. The user can receive a direct, live statement of his account balance with the payee accounting for real time events, such as payments received or services used.

At element 810, a transaction can be established between the user and the entity (payee). This transaction can be an electronic funds transfer that can pay bills for services provided by the entity. The transaction can be established on a one-time basis. The transaction can also be established on a recurring basis, such as a periodic basis. Additionally, historical information can be retrieved from the user, the entity or the account database regarding credits or debits associated with the user's accounts.

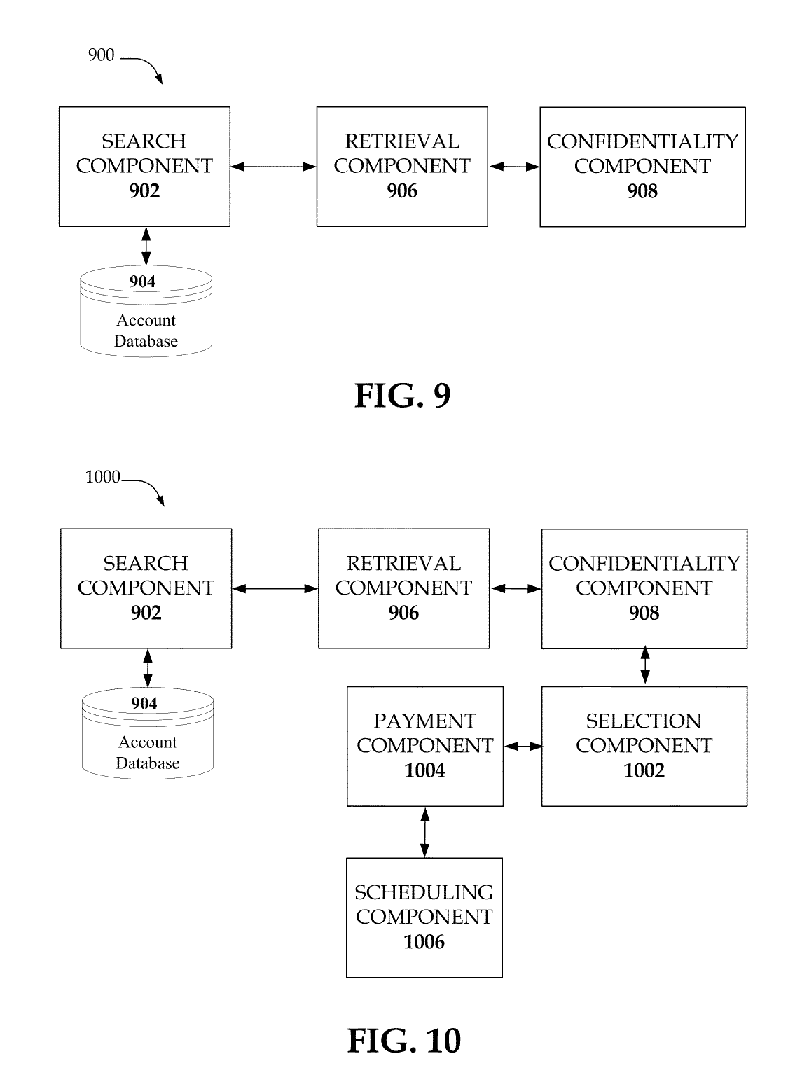

Referring now to FIG. 9, illustrated is a schematic system block diagram of a system 900 that ensures only non-confidential account information is displayed. The system 900 can include a search component 902 that can search an account database 904 for a payee based on a criterion of the payee. For example, this database can be a database of registered users with the system 900. The search can be for a specific payee according to a criterion, such as a type. The type can be a name, an address, a service provided, a business type, a relationship, or the like. For example, the criteria can be “Joe Smith.” Further criteria can also be established, such as, “Los Angeles, Calif.” The database can find registered users named Joe Smith that satisfies the criteria. For example, there can be 20 users satisfying the criteria “Joe Smith” and “Los Angeles, Calif.”

The system 900 can also include a retrieval component 906 that can receive account information of the payee. Account information can be retrieved for all 20 of the Joe Smiths in the previous example. However, the user who initiated the search should not be able to view all of the account information. The user who initiated the search should be able to view only enough information to distinguish the correct Joe Smith.

Accordingly, the system 900 can also include a confidentiality component 910 that can select a portion of the account information of the payee to be displayed. This can allow only non-confidential information to be displayed. In the example above, the account information for each Joe Smith can include a name, a date of birth, an address, a beneficiary, an account number, a balance, an origination date, and the like. The confidentiality component can select only non-confidential information to be displayed, such as a name and an address or date of birth (information that is included in public records). The other information, such as the beneficiary, the account number, the balance, the origination date, and other confidential information can be kept confidential so the user who initiated the search cannot see this information. In the case where enough criteria are entered to isolate a single Joe Smith, only non-confidential information can be displayed.

Referring now to FIG. 10, illustrated is a schematic system block diagram of a system 1000 that can establishes a transaction between a payer and payee. The system 1000 can include a search component 902, a retrieval component 904 and a confidentiality component 906 with functionalities described with respect to FIG. 9. System 1000 can also include a selection component 1002 and a payment component 1004 with additional functionalities that can facilitate a transaction between a payer and payee.

The selection component 1002 can include an interface that can display the non-confidential account information. For example, as described above, the interface can display the 20 Joe Smiths that satisfied the criteria of “Joe Smith” and “Los Angeles.” The interface can display non-confidential account information associated with each Joe Smith (e.g., in a list). This can enable the user to find the correct Joe Smith, but does not enable the user to view any confidential information. The selection component 1002 can receive a selection of a payee based on the account information. For example, the user can select a Joe Smith with an associated address of 123 Alpha St. in Los Angeles, Calif.

The payment component 1004 can link the user to the selected payee based on the selection according to the displayed account information. The payment component 1004 can also establish a transaction, such as an electronic funds transfer. This transaction can be a one-time payment or a recurring payment. According to the previous example, a recurring payment can be established between the user and Joe Smith on a monthly basis to cover a court-ordered child support payment.

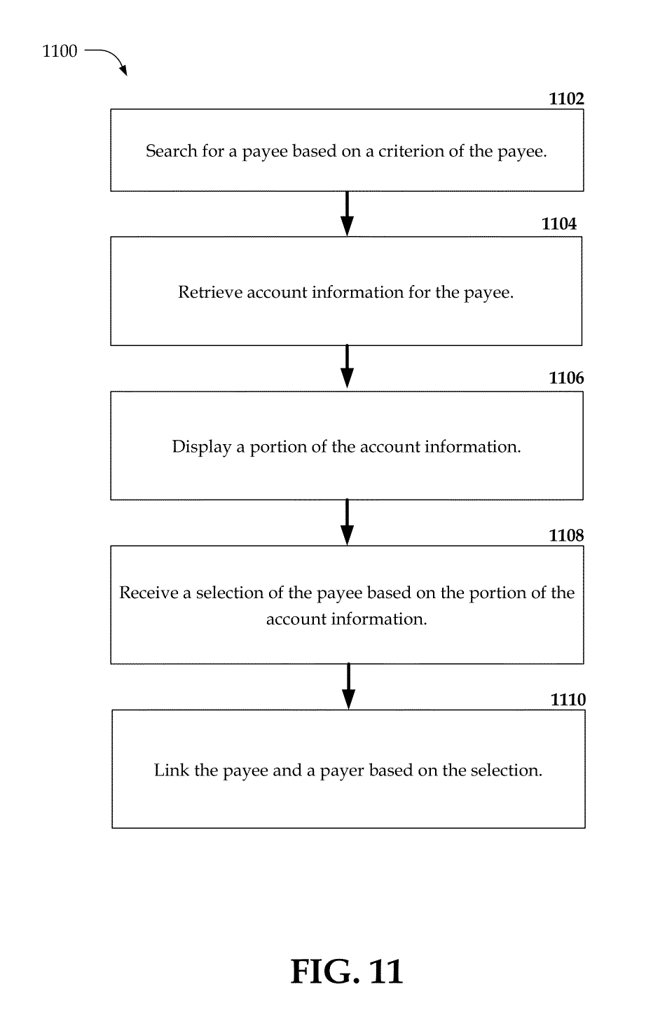

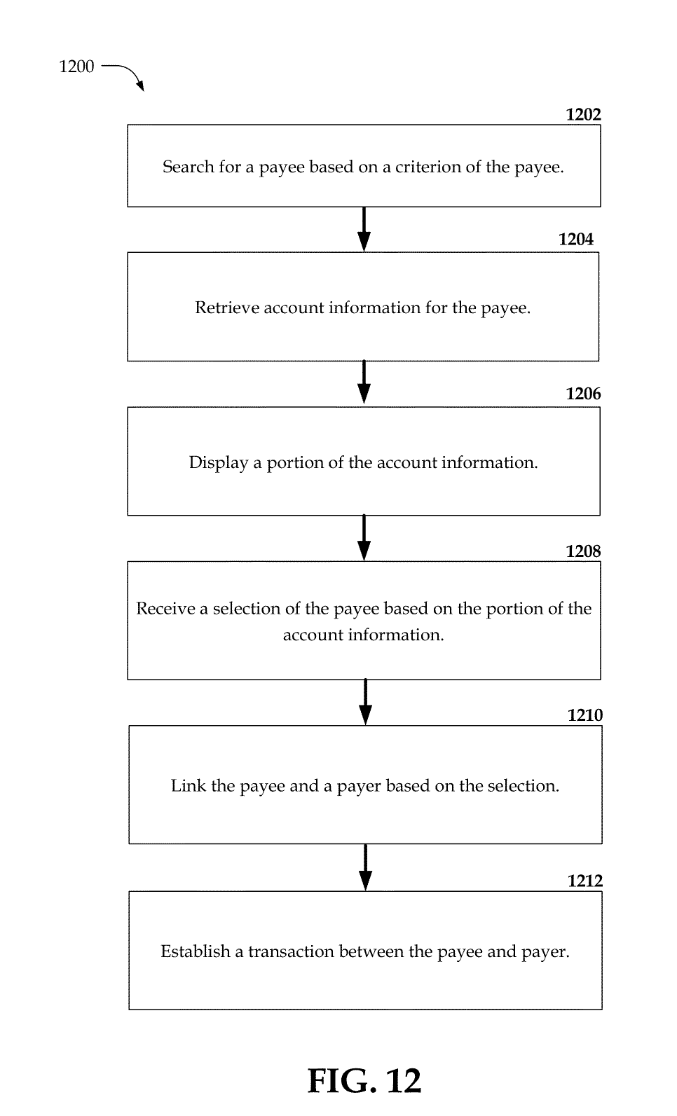

FIGS. 11-12 illustrate methods that facilitate establishing a transaction between a payee and a payer. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium) to facilitate transporting and transferring such methodologies to computers. The term article of manufacture, as used herein, is intended to encompass a computer program accessible from any computer-readable device, carrier, or media, including a non-transitory computer readable storage medium.

Referring now to FIG. 11, illustrated is a schematic process flow diagram of a method 1100 that facilitates linking a payee and a payer. At element 1102, a search for a payee can be conducted based on a criterion of the payee. The search can be conducted in an account database for registered account holders satisfying the criterion. The criterion can be a name, an address, a service provided, a business type, a relationship, or the like.

At element 1104, account information for a payee satisfying the criterion can be retrieved. At element 1106, a portion of the account information can be displayed. The user who initiated the search is not entitled to view all of the account information, including confidential information, such as an account number. Only non-confidential information, such as a name, an address, or other information appearing in public records, can be displayed. Based on this displayed portion of the account information, at element 1108, a selection of a payee can be received. At element 1110, the selected payee and a payer can be linked so facilitate future transactions.

Referring now to FIG. 12, illustrated is a schematic process flow diagram of a method 1200 that establishes a transaction between a payee and a payer. At element 1202, a search for a payee can be conducted based on a criterion of the payee. The search can be conducted in an account database for registered account holders satisfying the criterion. The criterion can be a name, an address, a service provided, a business type, a relationship, or the like.

At element 1204, account information for a payee satisfying the criterion can be retrieved. At element 1206, a portion of the account information can be displayed. The user who initiated the search is not entitled to view all of the account information, including confidential information, such as an account number. Only non-confidential information, such as a name, an address, or other information appearing in public records, can be displayed. Based on this displayed portion of the account information, at element 1208, a selection of a payee can be received. At element 1210, the selected payee and a payer can be linked so facilitate future transactions.

At element 1212, a transaction can be established between the user and the entity (payee). This transaction can be an electronic funds transfer that can pay bills for services provided by the entity. The transaction can be established on a one-time basis. The transaction can also be established on a recurring basis, such as a periodic basis. For example, using the previous example, a recurring payment can be established between the user and Joe Smith on a monthly basis to cover a court-ordered child support payment.

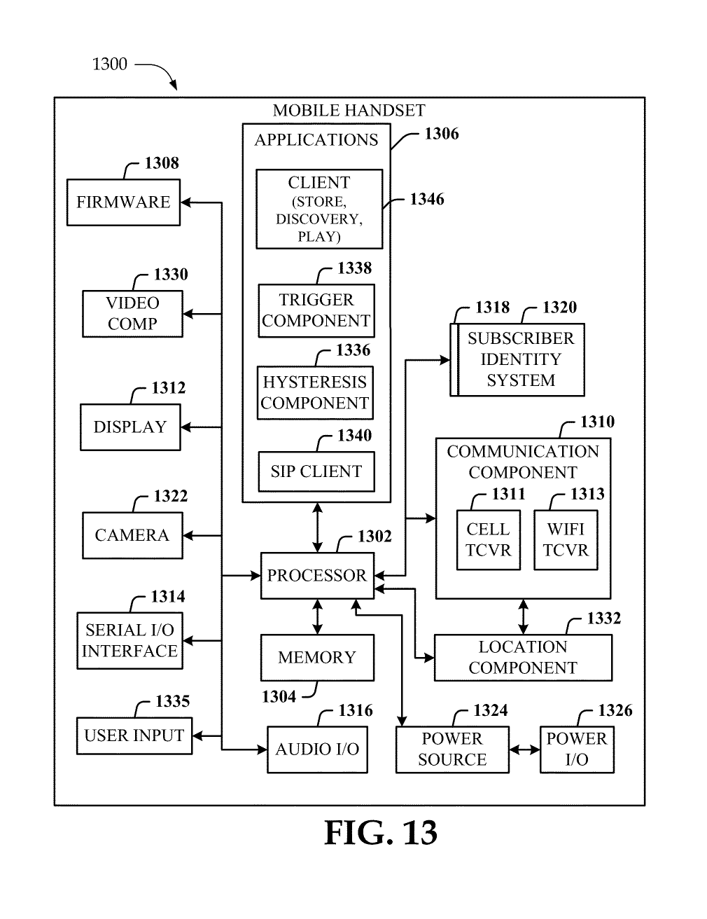

Referring now to FIG. 13, illustrated is a schematic block diagram of an exemplary mobile device 1300 capable of generating, editing and sharing video clips in accordance with some embodiments described herein. Although a mobile handset 1300 is illustrated herein, it will be understood that other devices can be a mobile device, and that the mobile handset 1300 is merely illustrated to provide context for the embodiments of the innovation described herein. The following discussion is intended to provide a brief, general description of an example of a suitable environment 1300 in which the various embodiments can be implemented. While the description includes a general context of computer-executable instructions embodied on a computer readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., WiFi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 1300 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the WiFi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 1310, includes an indoor network radio transceiver 1313 (e.g., WiFi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

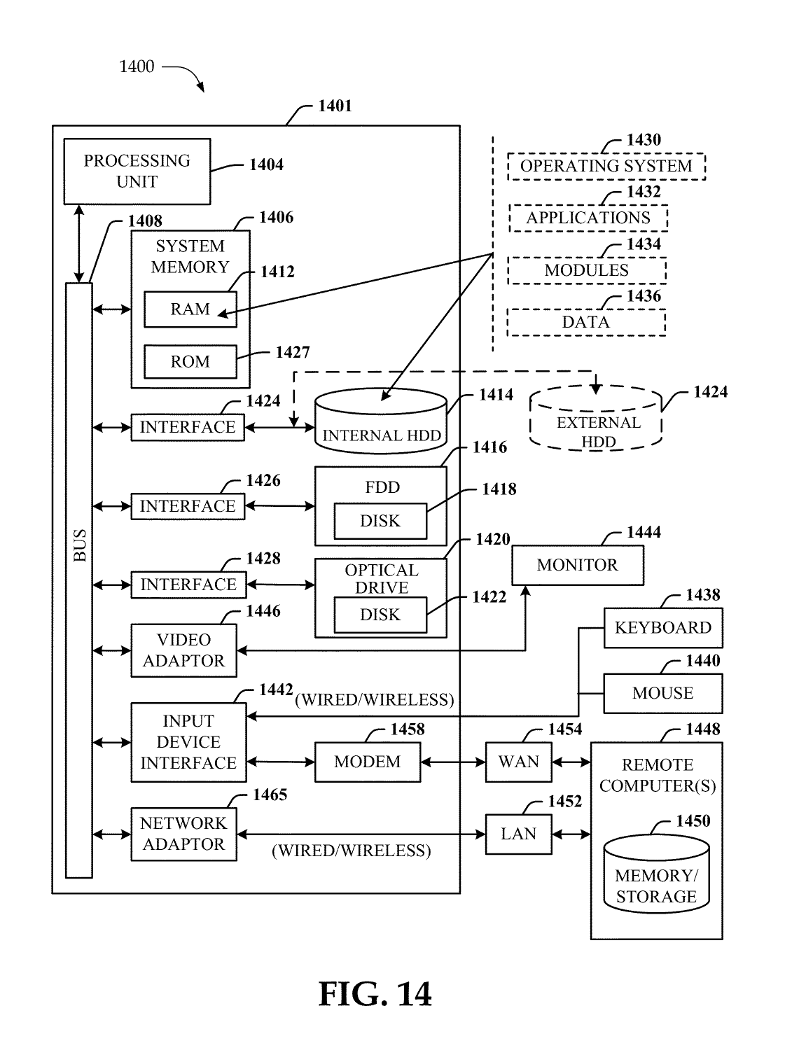

Referring now to FIG. 14, there is illustrated a block diagram of a computer operable to execute a system architecture that facilitates generating, editing, and sharing of video quotes. The computer can provide networking and communication capabilities between a wired or wireless communication network and a server and/or communication device. In order to provide additional context for various aspects thereof, FIG. 14 and the following discussion are intended to provide a brief, general description of a suitable computing environment 1400 in which the various aspects of the innovation can be implemented to facilitate the generation, editing, and sharing of video quotes. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the exemplary environment 1400 for implementing various aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 can also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1411 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1494 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is to be appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 2394 serial port, a game port, a USB port, an IR interface, etc.

A monitor 1444 or other type of display device is also connected to the system bus 1408 through an interface, such as a video adapter 1446. In addition to the monitor 1444, a computer typically includes other peripheral output devices (not shown), such as speakers, printers, etc.

The computer 1402 can operate in a networked environment using logical connections by wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 through the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
a memory that stores computer-executable instructions; and
a processor that facilitates execution of the computer-executable instructions to at least:
display a list of payees to a payer, wherein the list is based on a type of payee, the list comprises payees designated as friends of the payer and the list is constructed based on a social graph data structure;
receive information indicating aChj selection of a payee from the list of payees by the payer; and
initiate a transaction between the payee and at least one of a first account of the payer or a second account of the payer.

2. The system of claim 1, wherein the first account or the second account is a bank account.

3. The system of claim 1, wherein the first account or the second account is a credit card account.

4. The system if claim 1, wherein the first account or the second account is a loan account.

5. The system of claim 1, wherein the first account is associated with a first bank and the second account is associated with a second bank.

6. The system of claim 1, wherein the transaction comprises paying the payee an amount from at least one of the first account or the second account.

7. The system of claim 1, wherein the transaction comprises paying the payee a first amount from the first account and a second amount from the second account.

8. The system of claim 1, wherein the transaction comprises scheduling a future payment to the payee from at least one of the first account or the second account.

9. The system of claim 1, wherein the friends of the payer comprise friends registered with the system and represented in the social graph data structure.

10. The system of claim 9, wherein the processor further facilitates the execution of the computer-executable instructions to receive an input of a name, search a database of registered users of the system for the name, and display the name as a friend of the payee.

11. The system of claim 9, wherein the processor further facilitates the execution of the computer-executable instructions to send a notification with instructions of how to register with the system in response to the name not being found.

12. (canceled)

13. A method, comprising:
displaying, by a system comprising a processor, a list of payees to a payer based on a type of payee, wherein the list comprises friend data representing friends of the payer and the list is constructed based on a social graph data structure;
receiving, by the system, information indicating a selection of a payee from the list of payees by the payer; and
completing, by the system, an action between the payee and at least one of a first account or a second account of the payer.

14. The method of claim 13, wherein at least one of the first account or the second account comprises a bank account.

15. The method of claim 13, wherein at least one of the first account or the second account comprises a credit card account.

16. The method of claim 13, wherein at least one of the first account or the second account comprises a loan account

17. The method of claim 13, wherein at least one of the first account or the second account is associated with a bank.

18. The method of claim 13, wherein the completing the action further comprises paying the payee an amount from the first account or the second account.

19. The method of claim 13, wherein the completing the action further comprises paying the payee a first amount from the first account and a second amount from the second account.

20. The method of claim 13, wherein the completing the action further comprises scheduling a future payment to the payee from the first account or the second account.

21. (canceled)

22. (canceled)

23. The method of claim 13, wherein the displaying the list further comprises displaying the friends of the list based on a historical relationship.

24. A computer-readable storage medium having instructions stored thereon that, in response to execution, cause a device comprising a processor to perform operations, comprising:
searching for a plurality of registered payees based on a criterion established by a payer;
displaying a list of the plurality of registered payees satisfying the criterion to the payer, wherein the list comprises identifiers of friends of the payer and the list is constructed based on a social graph data structure;
receiving information indicating a selection of a payee from the list of the plurality of registered payees by the payer; and
completing a transaction between the payee and at least one of a first account of the payer or a second account of the payer.

25-51. (canceled)

52. The computer-readable storage medium of claim 24, wherein the social graph data structure is based on a global mapping of how the payer and the plurality of registered payees are related online.

53. The computer-readable storage medium of claim 52, wherein the social graph data structure stores information from a friends list on a social network service.

54. The computer-readable storage medium of claim 52, wherein the social graph data structure is established based on an artificial intelligence analysis of relationships determined to be applicable to the payer.

55. The computer-readable storage medium of claim 54, wherein the artificial intelligence analysis is based on a neural network, a classifier or a support vector machine.

56. The computer-readable storage medium of claim 52, wherein the social graph data structure is established based on one or more historical relationships between the payer and the plurality of registered payees.

57. The system of claim 1, wherein the social graph data structure is based on a global mapping of how the payer and the plurality of registered payees are related online.

58. The system of claim 57, wherein the social graph data structure stores information from a friends list on a social network service.

59. The system of claim 57, wherein the social graph data structure is established based on an artificial intelligence analysis of relationships determined to be applicable to the payer.

60. The system of claim 57, wherein the artificial intelligence analysis is based on a neural network, a classifier or a support vector machine.

60. The system of claim 57, wherein the social graph data structure is established based on one or more historical relationships between the payer and the plurality of registered payees.

62. The method of claim 13, wherein the social graph data structure is based on a global mapping of how the payer and the plurality of registered payees are related online.

63. The method of claim 62, wherein the social graph data structure stores information from a friends list on a social network.

64. The method of claim 62, wherein the social graph data structure is established based on an artificial intelligence analysis of relationships determined to be applicable to the payer.

65. The method of claim 62, wherein the artificial intelligence analysis is based on a neural network, a classifier or a support vector machine.

66. The method of claim 62, wherein the social graph data structure is established based on one or more historical relationships between the payer and the plurality of registered payees.

67. A mobile device, comprising:
a memory that stores computer-executable instructions; and
a processor, coupled to the memory, that facilitates execution of the computer-executable instructions to perform operations, comprising:
displaying a list of payees to a payer, wherein the list is based on a type of payee, the list comprises friend data representing friends of the payer and the list is constructed based on a social graph data structure;
receiving information indicating a selection of a payee from the list of payees by the payer; and
performing a transaction between the payee and at least one of a first account of the payer or a second account of the payer.

68. The mobile device of claim 67, wherein the social graph data structure is based on a global mapping of how the payer and the plurality of registered payees are related online.

69. The mobile device of claim 68, wherein the social graph data structure stores information from a friends list on a social network.

70. The mobile device of claim 68, wherein the social graph data structure is established based on an artificial intelligence analysis of relationships determined to be applicable to the payer.

71. The mobile device of claim 68, wherein the artificial intelligence analysis is based on a neural network, a classifier or a support vector machine.

72. The mobile device of claim 68, wherein the social graph data structure is established based on one or more historical relationships between the payer and the plurality of registered payees.
